(19) United States
(12) Patent Application Publication
(10) Pub. No.: US 2023/0402027 A1
(43) Pub. Date: Dec. 14, 2023

(54) NOISE MASKS FOR VIRTUAL REALITY HEADSET COOLING FANS

(71) Applicant: HEWLETT-PACKARD DEVELOPMENT COMPANY, L.P., Spring, TX (US)

(72) Inventors: Kuanlin Li, Taipei City (TW); Travis Shih, Taipei City (TW)

(21) Appl. No.: 17/748,367

(22) Filed: May 19, 2022

(51) Int. Cl. G10K 11/175; H04R 1/10; H04R 1/08; G10K 11/162; G06F 1/16; G06F 1/20

(52) U.S. Cl. CPC G10K 11/1752; H04R 1/1083; H04R 1/08; H04R 2499/15; G06F 1/163; G06F 1/203; G10K 11/162

(57) ABSTRACT

In example implementations, a virtual reality (VR) head mounted display (HMD) is provided. The VR HMD includes a cooling fan to generate air flow to reduce a temperature within the VR HMD during operation of the VR HMD and a noise masking component to mask noise generated by the cooling fan.

### BACKGROUND

Virtual reality (VR) head mounted displays (HMDs) can provide users with an immersive experience. VR HMDs can be used to provide entertainment, to provide training, or to provide education.

VR HMDs include all-in-one VR HMDs that include all of the hardware necessary to execute a VR application. For example, an all-in-one VR HMD does not connect to an external computing device to operate. Rather, the processor, memory, graphics processor, and all other hardware is contained within a housing of the all-in-one VR HMD.

### BRIEF DESCRIPTION OF THE DRAWINGS

FIG. 1 is a block diagram of a VR HMD with an example noise masking of the present disclosure;

FIG. 2 is a more detailed block diagram of the VR HMD with the example noise masking of the present disclosure;

FIG. 3 is an example graph illustrating how a sound level of a masking tone can mask a prominent tone of noise generated by the cooling fan of the present disclosure;

FIG. 4 is an example graph illustrating how a masking tone masks the noise generated from a cooling fan in the VR HMD of the present disclosure;

FIG. 5 is a flow chart of an example method to mask cooling fan noise in a VR HMD of the present disclosure;

FIG. 6 is a flow chart of another example method to mask cooling fan noise in a VR HMD of the present disclosure;

FIG. 7 is a block diagram of another VR HMD with an example noise masking for of the present disclosure;

FIG. 8 is a block diagram of another VR HMD with an example noise masking of the present disclosure;

FIG. 9 is a block diagram of an example noise attenuation feature that includes pores in a housing of the VR HMD; and

FIG. 10 is a block diagram of an example noise attenuation feature that includes dimples on an inner surface of the housing of the VR HMD.

### DETAILED DESCRIPTION

Examples described herein provide an apparatus and method to mask cooling fan noise in a VR HMD. As discussed above, VR HMDs include all-in-one VR HMDs that include all of the hardware necessary to execute a VR application. For example, an all-in-one VR HMD does not connect to an external computing device to operate. Rather, the processor, memory, graphics processor, and all other hardware is contained within a housing of the all-in-one VR HMD.

However, an all-in-one VR HMD may also include a cooling fan to help dissipate heat away from the internal components that may be sensitive to overheating. As the internal temperature of the all-in-one VR HMD rises, the air flow of the cooling fan may also be gradually increased. The increase in air flow may cause an increase in fan noise. However, large amounts of fan noise can be a distraction for a user of the all-in-one VR HMD.

The present disclosure provides an apparatus and method that can mask the noise generated by the cooling fan of the all-in-one VR HMD. The present disclosure provides a noise masking component. The noise masking component may be an electrical component or a physical component.

In an example, an electrical noise masking component may generate a masking tone to help lower the perceived sound pressure heard by a user of the VR HMD (e.g., measured in decibels (dBA) or dB). In an example, the electrical noise masking component may also include an audio codec that can analyze the noise from the cooling fan to generate an anti-noise masking signal.

In an example, a physical noise masking component may include noise attenuation features in the housing of the VR HMD. For example, the noise attenuation features may include pores within the housing of the VR HMD or dimples on an inner surface of the VR HMD.

As a result, the present disclosure may mask cooling fan noise using methods that are easier to implement and have a lower cost than previous methods. For example, the noise masking component of the present disclosure may not compromise performance for lower temperature, may not rely on the use of expensive materials with high thermal conductivity, and may not implement sophisticated structures such as heat pipes, vapor chambers, specialized coatings, and the like that can add to manufacturing costs.

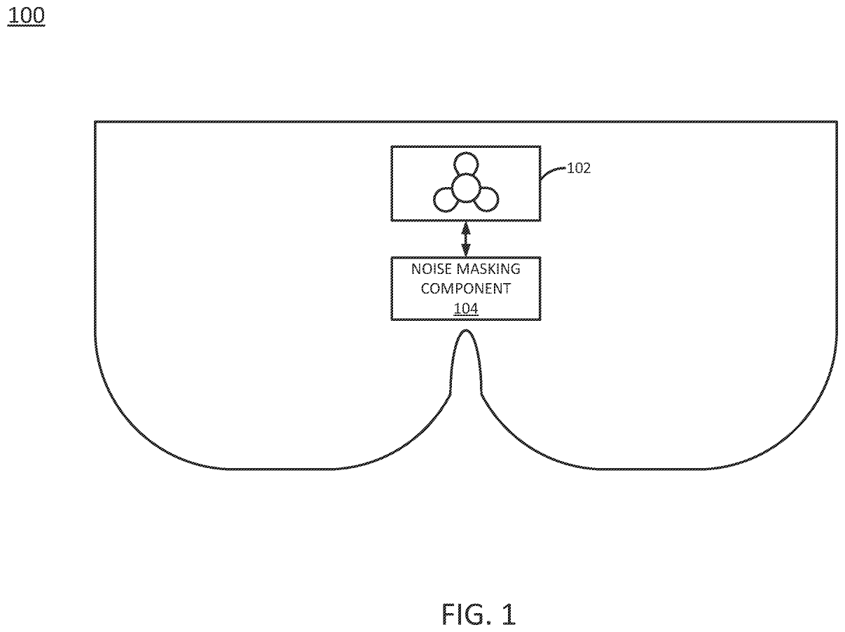

FIG. 1 illustrates a VR HMD 100 with an example noise masking component 104 of the present disclosure. It should be noted that the VR HMD 100 has been simplified for ease of explanation and may include other components not shown. For example, the VR HMD 100 may include a display, speakers, a processor, a graphics processor, memory, and the like.

In an example, the VR HMD 100 may include a cooling fan 102 and the noise masking component 104. As noted above, during operation of the VR HMD 100, the cooling fan 102 may operate to lower the internal temperature of the VR HMD 100. For example, the processor, graphics processor, heat generated from lighting of the display, and the like, can generate heat. The cooling fan 102 may operate to create air flow to dissipate heat out of the internal volume of the housing of the VR HMD 100.

The cooling fan 102 may generate noise during operation. If background noise is present, the noise generated by the cooling fan 102 may not be noticeable. However, as the temperature increases within the VR HMD 100, the cooling fan 102 may operate at higher power levels to increase air flow. The higher the power level, the more noise the cooling fan 102 may generate. If the noise level increases well above the background noise level, the noise from the cooling fan 102 may become a distraction for the user of the VR HMD 100.

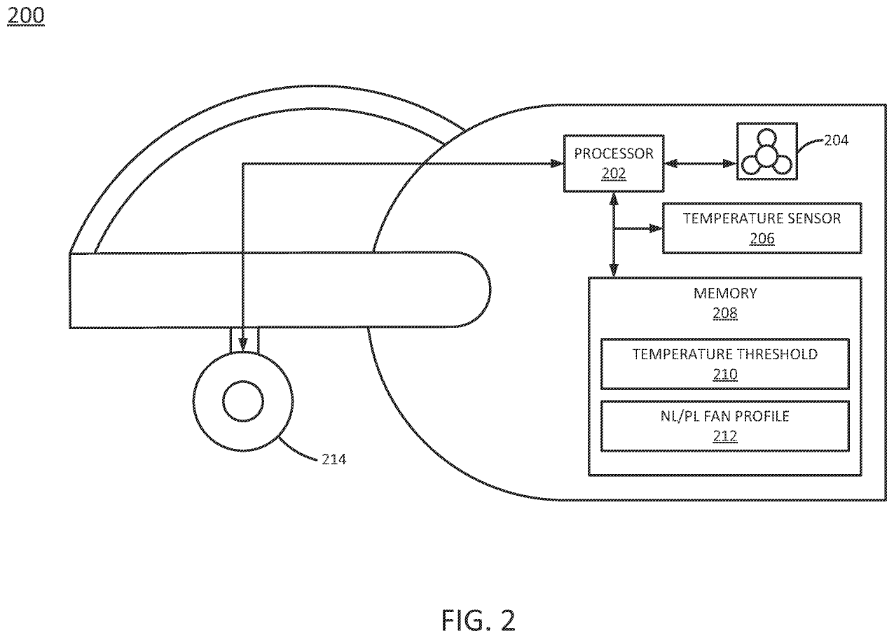

The noise masking component 104 may mask noise generated by the cooling fan 102 to make the noise generated by the cooling fan 102 less noticeable to the user. The noise masking component 104 may be an electrical noise masking component or a physical noise masking component. For example, an electrical noise masking component may generate a masking tone, or a noise masking audio signal to cancel the noise from the cooling fan 102. Examples of an electrical noise masking component are illustrated in FIGS. 2-7 and discussed in further detail below.

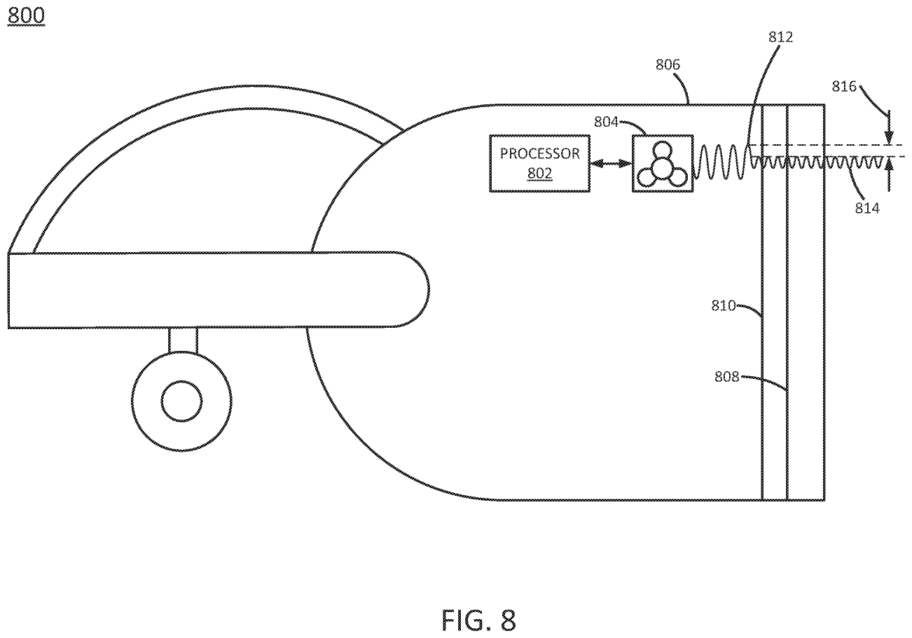

A physical noise masking component may include a noise attenuation feature. The noise attenuation feature may reduce the noise generated by the cooling fan 102 using physical structures within the housing of the VR HMD 100. Examples of noise attenuation features are illustrated in FIGS. 8-10 and discussed in further detail below.

FIG. 2 illustrates a more detailed block diagram of a VR HMD 200 with an example electrical noise masking component of the present disclosure. The electrical noise masking component in the VR HMD 200 may mask the noise generated by a fan by changing or reducing a relative noise level of the fan compared to the perceived background noise level. For example, a masking tone may be generated to add sound pressure or sound level to the background noise level to reduce the relative difference between the fan noise level and the background noise level plus the masking tone level.

The VR HMD 200 may include a processor 202, a cooling fan 204, a temperature sensor 206, a memory 208, and a speaker 214. The processor 202 may be communicatively coupled to the cooling fan 204, the temperature sensor 206, the memory 208, and the speaker 214. The processor 202 may control operation of the cooling fan 204 and the speaker 214.

The processor 202 may receive temperature measurements of a temperature within a housing of the VR HMD 200. The temperature measurements may be correlated to whether the cooling fan 204 is activated and how much power is consumed by the cooling fan 204 for a given temperature. Based on the amount of power consumed by the cooling fan 204, the processor 202 may determine an amount of noise generated by the cooling fan 204. The masking tone generated by the processor 202 may be generated at a volume to mask the amount of noise generated by the cooling fan 204 for a given power output at a given temperature, as discussed in further detail below.

The processor 202 may execute instructions stored in the memory 208 to perform the functions described herein. The memory 208 may also store a temperature threshold 210 and a noise level to power level profile 210 of the cooling fan 212 (also referred to as the NL/PL fan profile 212 or simply profile 212). The temperature threshold 210 may be a predetermined temperature at which the processor 202 generates a masking tone. As noted above, when the noise generated by the cooling fan 204 is below a background noise level, the user may not notice the noise from the cooling fan 204. However, as temperatures rise within the VR HMD 200, the cooling fan 204 may increase power to increase airflow to lower the temperature. The noise generated by the cooling fan 204 may increase above the background noise level. The temperature threshold 210 may be correlated to a temperature at which the cooling fan 204 generates an amount of noise greater than the background noise (e.g., more power to increase airflow causes more fan noise due to higher temperatures) such that the processor 202 generates a masking tone.

In an example, the profile 212 may be predetermined based on the cooling fan 204. For example, each brand of cooling fan or model number of different cooling fans may have a different predetermined profile 212. The profile 212 may correlate a noise level generated by a cooling fan at different power outputs. The processor 202 may know what power level to apply to the cooling fan 204 for a given temperature to set a proper airflow to reduce the temperature. Thus, the processor 202 may determine an appropriate volume level or masking tone level based on the noise level of the cooling fan 204 obtained from the profile 212 and the desired power level for the measured temperature within the VR HMD 200.

The masking tone may be used to make the noise generated by the cooling fan 204 less noticeable to the user during operation of the cooling fan 204. The masking tone does not physically alter the sound signal from the cooling fan 204. For example, a noise at a particular volume or decibel level may not be noticeable in an environment with a large amount of background noise. However, the noise at the same volume or decibel level may be very noticeable in a quiet environment with little background noise. Thus, the masking tone may be generated by the processor 202 to simulate an increase in background noise to make the noise generated by the cooling fan 204 less noticeable to the user.

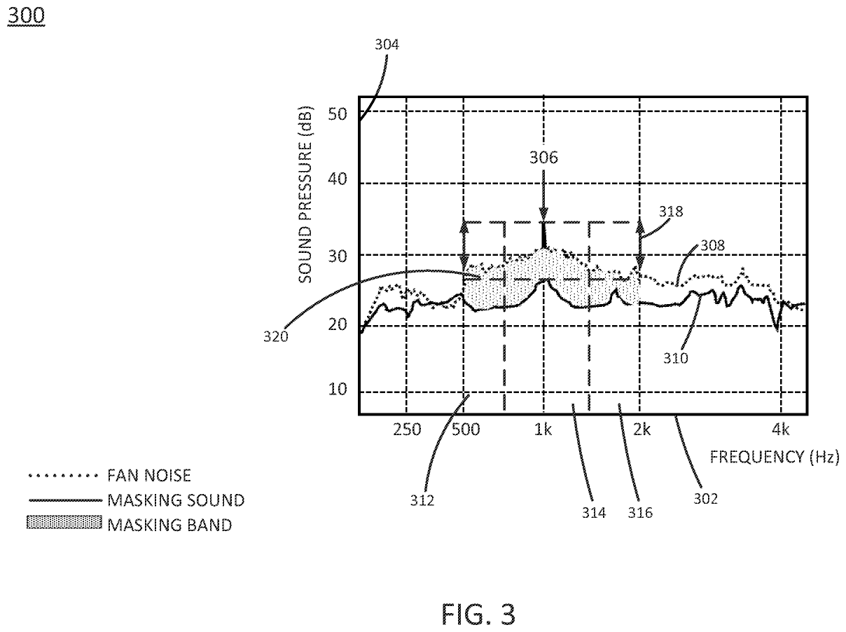

FIG. 3 graphically illustrates how the noise from the cooling fan 204 can be masked. FIG. 3 illustrates a graph 300. The graph 300 illustrates sound pressure or noise measured in decibels (dB) across various frequencies measured in Hertz (Hz). The graph 300 illustrates a fan noise level 310 and a masking tone or sound level 308. The fan noise may be noticeable when a prominent peak 306 is detected at a particular frequency.

In an example, the prominent peak 306 may be detected when a prominence ratio is greater than a predetermined level of two adjacent frequency bands. The predetermined level may be different for different users. For example, some users may be more sensitive to fan noise even with large amounts of background noise, while other users may be less sensitive to fan noise even when there is little background noise. In an example, for the average user, the predetermined level may be approximately 9 dB or higher.

The prominent peak 306 may be detected within a frequency range that is likely to be most generated frequency noise from the cooling fan 204. In the example illustrated in FIG. 3, an analyzed frequency band 314 may be between 750 Hz to 1500 Hz. Adjacent frequency bands may include a frequency band 312 at about 500 Hz to 750 Hz and a frequency band 316 at about 1500 Hz to 2000 Hz.

The prominence ratio may be calculated in accordance with a function as follows:

Prominence Ratio=10*Log [B/(A+C)*0.5)]

where B is the frequency band 314, A is the frequency band 312, C is the frequency band 316.

When the prominence ratio is greater than the predetermined level (e.g., 9 dB) the prominent peak 306 may be detected. The masking tone or sound 308 may be generated to add decibels or sound levels to the fan noise level 310 to mask the prominent peak 306. The added sound level is shown by a masking band 320 in the graph 300. The masking tone 308 may be set to ensure that the difference in the prominent peak 306 and the masking tone 308 is less than the predetermined level (e.g., 9 dB) as illustrated by arrows 318.

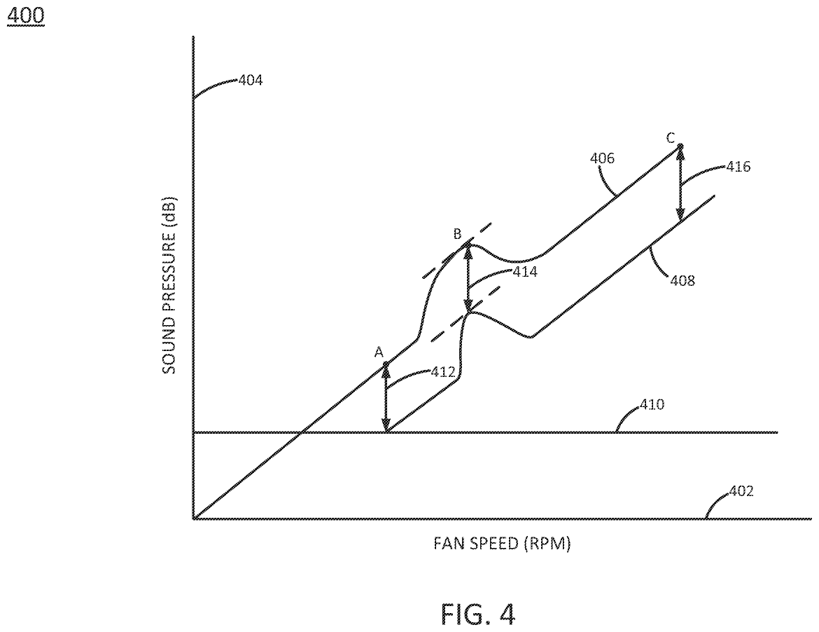

FIG. 4 illustrates a graph 400 that illustrates how the electrical noise masking component may operate in the VR HMD 200. For example, the graph 400 illustrates an axis 402 that represents a fan speed in rotations per minute (RPM) and an axis 404 that represents sound pressure in decibels (dB). A line 410 may represent a background noise level. When the cooling fan 204 operates at a speed that generates noise below the background noise level 410, the masking tone may not be generated as the fan noise may not be noticeable to the user.

However, as the temperature within the VR HMD 200 rises, the fan speed may increase. As the fan speed increases, the noise generated by the fan may increase as shown by a line 406. When the fan noise increases above the background noise 410, the processor 202 may begin generating the masking tone at a desired noise level as shown by a line 408. The masking tone level may increase at a same rate as the fan noise level 406 increases. The masking tone level 408 may be set at a volume to ensure that the difference between the fan noise level 406 and the masking tone level 408 is less than a predetermined level (e.g., 9 dB), as described above, and as shown by arrows 412, 414, and 416.

FIG. 4 also illustrates an example prominent peak at point B. The masking tone level 408 may be adjusted similarly to mask the prominent peak at point B as shown by the constant size of the arrows 412, 414 and 416 across the entire line of the fan noise level 406 and the masking tone level 408.

In an example, the line 410 may also represent a temperature threshold at which the masking tone would be generated by the processor 202. As discussed above, the cooling fan 204 may operate at a particular power level at different temperatures. The fan speed above a background noise level may be correlated to a particular temperature using the profile 212. For example, to be above the background noise level, the fan may operate at a particular fan speed. The fan speed may be associated with a particular power level that is used for a particular temperature.

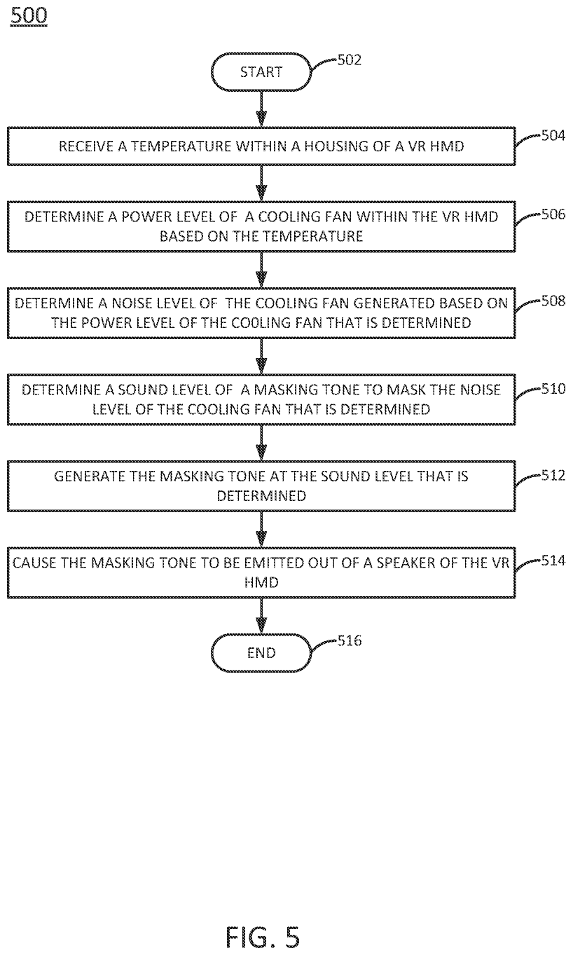

FIG. 5 illustrates a flow diagram of an example method 500 for masking cooling fan noise in a VR HMD of the present disclosure. In an example, the method 500 may be performed by the VR HMD 100 illustrated in FIG. 1 or the VR HMD 200 illustrated in FIG. 2.

At block 502, the method 500 begins. At block 504, the method 500 receives a temperature within a housing of a VR HMD. For example, a temperature sensor may measure an internal temperature within the VR HMD as the VR HMD is in use.

At block 506, the method 500 determines a power level of a cooling fan within the VR HMD based on the temperature. For example, a relationship between internal temperature and the amount of power delivered to the cooling fan to generate a desired amount of air flow (e.g., X number of RPMs to move Y cubic feet per minute (cfm) of air flow) may be predefined. Thus, based on the measured temperature, the processor of the VR HMD may determine how much air flow is used to reduce the internal temperature to a desired temperature. The amount of air flow may be correlated to an amount of power.

At block 508, the method 500 determines a noise level of the cooling fan generated based on the power level of the cooling fan that is determined. In an example, a noise level to power level profile of the cooling fan may be stored in memory for a particular model or brand of cooling fan. The determined power level may be used to determine a noise level of the cooling fan at a particular power level.

At block 510, the method 500 determines a sound level of a masking tone to mask the noise level of the cooling fan that is determined. Based on the noise level of the fan, the processor of the VR HMD may generate a masking tone with a volume level (e.g., measured in dB) that causes the noise level of the fan to be relatively quieter to the user. For example, the masking tone may be within a predetermined difference in decibel level (e.g., 9 dB, 4-15 dB, and the like).

In an example, the volume level of the masking tone may be based on an amount of background noise. For example, the masking tone may be generated to add an additional amount of background noise to the existing background noise such that the noise level of the fan is less than a desired decibel level from the combination of the background noise and the masking tone.

At block 512, the method 500 generates the masking tone at the sound level that is determined. In an example, the masking tone may be a static tone or white noise that is added. In another example, the masking tone may be prerecorded background noise that is played at a desired volume level.

At block 514, the method 500 causes the masking tone to be emitted out of a speaker of the VR HMD. For example, the masking tone may be emitted from the speaker of the VR HMD with any other sound output from an application being executed by the VR HMD. Thus, the masking tone may sound like additional background noise such that the user does not hear or notice the noise from the cooling fan. At block 516, the method 500 ends.

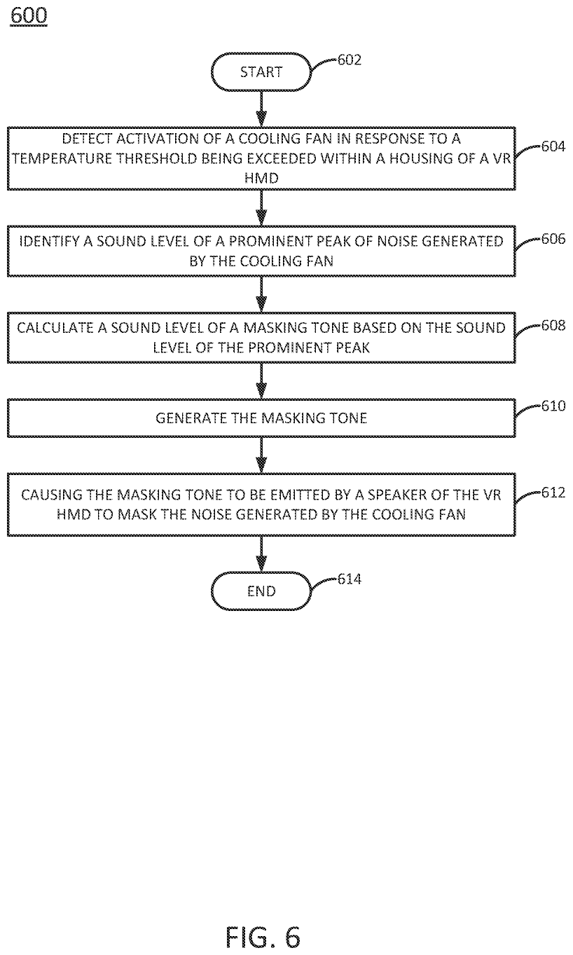

FIG. 6 illustrates another flow diagram of an example method 600 for masking cooling fan noise in a VR HMD of the present disclosure. In an example, the method 600 may be performed by the VR HMD 100 illustrated in FIG. 1 or the VR HMD 200 illustrated in FIG. 2.

At block 602, the method 600 begins. At block 604, the method 600 detects activation of a cooling fan in response to a temperature threshold being exceeded within a housing of the VR HMD. For example, the cooling fan may activate when the temperature threshold within the housing of the VR HMD is exceeded.

At block 606, the method 600 identifies a sound level of a prominent peak of noise generated by the cooling fan. For example, the prominent peak of noise generated by the cooling fan may be identified based on the prominence ratio function described above.

At block 608, the method 600 calculates a sound level of a masking tone based on the sound level of the prominent peak. For example, the prominent peak may represent the most noticeable noise from the cooling fan that is heard by the user. The masking tone may mask the prominent peak such that the prominent peak does not sound much louder than the background noise. In some examples, the user may not notice the prominent peak if the prominent peak has a difference of 9 dB or less from the masking tone or background noise. Thus, sound level of the masking tone may be calculated such that the difference in sound level between the masking tone and the prominent peak is less a predetermined or desired amount.

At block 610, the method 600 generates the masking tone. In an example, the masking tone may be a static tone or white noise that is added. In another example, the masking tone may be prerecorded background noise that is played at a desired volume level.

At block 612, the method 600 causes the masking tone to be emitted by a speaker of the VR HMD to mask the noise generated by the cooling fan. For example, the masking tone may be emitted from the speaker of the VR HMD with any other sound output from an application being executed by the VR HMD. Thus, the masking tone may sound like additional background noise, such that the user does not hear or notice the noise from the cooling fan. At block 614, the method 600 ends.

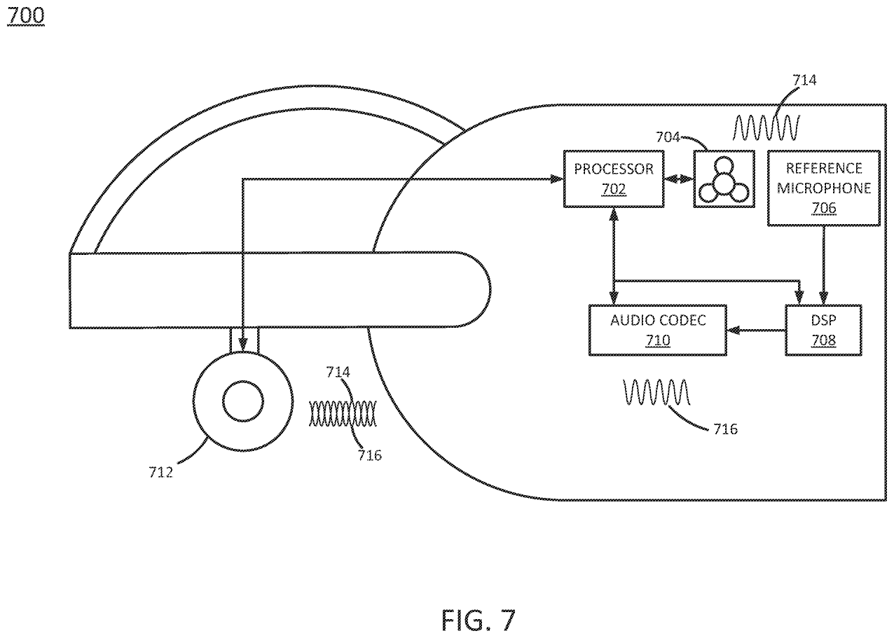

FIG. 7 illustrates another VR HMD 700 with an example electrical noise masking component. The electrical noise masking component of the VR HMD 700 may generate a counter signal to try to cancel or reduce the noise signal from the cooling fan.

In an example, the VR HMD 700 may include a processor 702, a cooling fan 704, a reference microphone 706, a digital signal processor (DSP) 708, an audio codec 710, and a speaker 712. The processor 702 may be communicatively coupled to the cooling fan 704, the reference microphone 706, the DSP 708, the audio codec 710, and the speaker 712. The processor 702 may control operation of the cooling fan 704, the reference microphone 706, the DSP 708, the audio codec 710, and the speaker 712.

In an example, the reference microphone 706 may receive a noise signal 714 generated by the cooling fan 704. The DSP 708 may convert the analog noise signal 714 into a digital version of the noise signal 714. The audio codec 710 may analyze the digital version of the noise signal 714 to generate a counter signal 716. The counter signal 716 may have a wave signal that is the opposite of the noise signal 714. For example, the counter signal 716 may have signal peaks where the noise signal 714 has signal valleys, and the counter signal 716 may have signal valleys where the noise signal 714 has signal peaks.

The processor 702 may cause the speaker 712 to emit the counter signal 716 as the noise signal 714 is being emitted by the cooling fan 704. The combination of noise signal 714 and the counter signal 716 is illustrated in FIG. 7. The combination of the noise signal 714 and the counter signal 716 may cause a noise signal to be emitted by the speaker 712 that can be perceived by a user to have a lower amplitude or lower sound level.

FIG. 8 illustrates another VR HMD 800 with an example physical noise masking component of the present disclosure. The VR HMD 800 may include a processor 802 that controls operation of a cooling fan 804. The VR HMD 800 may include a housing 806 that encloses the electrical components of the VR HMD 800, including the processor 802 and the cooling fan 804. A noise attenuation feature 810 may be coupled to an inside surface 808 of the housing 806 of the VR HMD 800.

In an example, the noise attenuation feature 810 may be coupled to the inside surface 808 that is adjacent to the cooling fan 804. For example, the inside surface 808 may be a surface within the housing 806 that is closest to the cooling fan 804. In another example, the inside surface 808 may be a surface within the housing 806 that is perpendicular or normal to an airflow direction of the cooling fan 804.

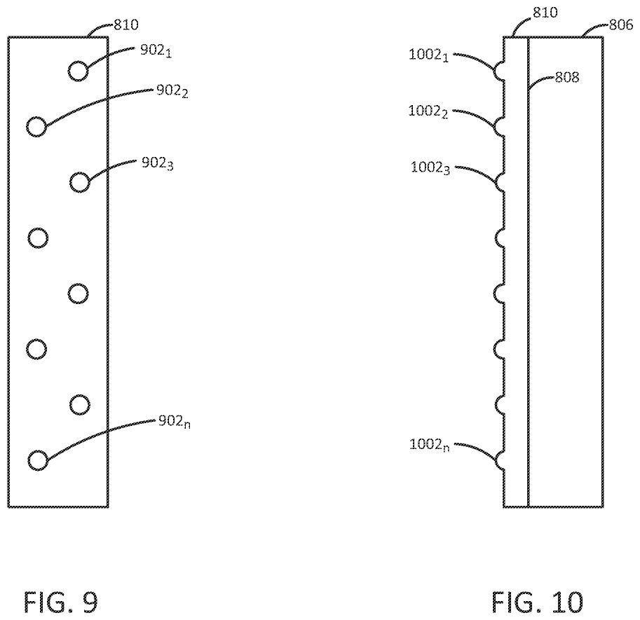

A noise signal 812 may exit the cooling fan 804 with a first amplitude. The noise signal 812 may pass through the noise attenuation feature 810. An exiting noise signal 814 may have a second amplitude or noise level that is lower than the first amplitude. In other words, the noise attenuation feature 810 may reduce the sound level of the noise signal 812 by a difference that is between the first amplitude and the second amplitude, as shown by arrows 816. FIG. 9 illustrates an example of the noise attenuation feature 810. In an example, the noise attenuation feature 810 may include a plurality of pores 902₁ to 902ₙ (hereinafter also referred to individually as a pore 902 or collectively as pores 902). In an example, the pores 902 may be formed in the inner surface 808 of the housing 806 via an injection molding process. For example, a supercritical fluid or liquid and a resin can be mixed as part of the injection molding process to form the pores 902. The supercritical fluid may be any substance at a temperature and pressure above its critical point.

FIG. 10 illustrates another example of the noise attenuation feature 810. In an example, the noise attenuation feature 810 may include a layer of dimples 1002₁ to 1002ₙ (hereinafter referred to individually as a dimple 1002 or collectively as dimples 1002). The dimples 1002 may be formed via a layer of soft material (e.g., rubber, foam, and the like). The layer of dimples 1002 may be applied to the inner surface 808 such that the dimples 1002 face the cooling fan 804. The layer of dimples 1002 may be applied to the inner surface 808 via an adhesive (e.g., a glue or tape), a mechanical coupling (e.g., a screw, nut and bolt, clip, and the like), heat compression, and the like.

Thus, the present disclosure provides various noise masking components that can mask the noise generated by a cooling fan. The noise masking component may be electrical or physical to mask the noise generated by the cooling fan, such that a user perceives a lower noise level from the cooling fan. As a result, the operation of the cooling fan and the performance of the VR HMD does not have to be compromised in trying to reduce the amount of noise generated by the cooling fan.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A virtual reality (VR) head mounted display (HMD), comprising:
a cooling fan to generate air flow to reduce a temperature within the VR HMD during operation of the VR HMD; and
a noise masking component to mask noise generated by the cooling fan.

2. The VR HMD of claim 1, wherein the noise masking component comprises an electrical noise masking component.

3. The VR HMD of claim 2, further comprising:
a memory to store a noise level to power level profile of the cooling fan;
a temperature sensor to measure the temperature within the VR HMD during operation of the VR HMD;
a speaker to emit a masking tone; and
a processor communicatively coupled to the memory and to the temperature sensor, wherein the processor is to determine a power level of the cooling fan at the temperature that is measured by the temperature sensor and to generate the masking tone in accordance with the noise level to power level profile to reduce a perceived noise level of the noise generated by the cooling fan.

4. The VR HMD of claim 3, wherein the processor is to generate the masking tone when the temperature that is measured by the temperature sensor exceeds a temperature threshold.

5. The VR HMD of claim 2, further comprising:
a microphone to receive the noise generated by the cooling fan;
a digital signal processor to convert the noise into a digital signal;
an audio codec to calculate a noise masking audio signal based on an analysis of the digital signal of the noise generated by the cooling fan;
a speaker to emit the noise masking audio signal; and
a processor communicatively coupled to the microphone, to the digital signal processor, to the audio codec, and to the speaker, the processor to control operation of the microphone, the digital signal processor, the audio codec, and the speaker.

6. The VR HMD of claim 1, wherein the noise masking component comprises a physical noise masking component.

7. The VR HMD of claim 6, wherein the physical noise masking component comprises a noise attenuation feature within a housing of the VR HMD.

8. The VR HMD of claim 7, wherein the noise attenuation feature comprises pores formed within a portion of the housing of the VR HMD located adjacent to the cooling fan.

9. The VR HMD of claim 8, wherein the pores are formed via an injection molding process.

10. The VR HMD of claim 7, wherein the noise attenuation feature comprises dimples formed on an inner surface of the housing of the VR HMD located adjacent to the cooling fan.

11. The VR HMD of claim 10, wherein the dimples are formed via a mold as part of the inner surface of the housing.

12. The VR HMD of claim 10, wherein the dimples comprise a rubber material or a foam material that is coupled to the inner surface of the housing.

13. The VR HMD of claim 12, wherein the rubber material or the foam material is coupled to the inner surface via an adhesive, a mechanical coupling, or heat compression.

14. A method, comprising:
receiving, via a processor of a virtual reality (VR) head mounted display (HMD), a temperature within a housing of the VR HMD;
determining, via the processor, a power level of a cooling fan within the VR HMD based on the temperature;
determining, via the processor, a noise level of the cooling fan generated based on the power level of the cooling fan that is determined;
determining, via the processor, a sound level of a masking tone to mask the noise level of the cooling fan that is determined;
generating, via the processor, the masking tone at the sound level that is determined; and
causing, via the processor, the masking tone to be emitted out of a speaker of the VR HMD.

15. The method of claim 14, wherein determining the noise level of the cooling fan generated based on the power level of the cooling fan is determined via a noise level to power level profile of a particular model number of the cooling fan that is stored in a memory of the VR HMD.

16. The method of claim 14, wherein the determining the power level of the cooling fan is performed in response to the temperature exceeding a temperature threshold.

17. The method of claim 14, wherein the sound level of the masking tone is less than a difference threshold between the noise level of the cooling fan and the sound level of the masking tone.

18. A method, comprising:
detecting, by a processor of virtual reality (VR) head mounted display (HMD), activation of a cooling fan in response to a temperature threshold being exceeded within a housing of the VR HMD;
identifying, by the processor, a sound level of a prominent peak of noise generated by the cooling fan;
calculating, by the processor, a sound level of a masking tone based on the sound level of the prominent peak;
generating, by the processor, the masking tone; and
causing, by the processor, the masking tone to be emitted by a speaker of the VR HMD to mask the noise generated by the cooling fan.

19. The method of claim 18, wherein the sound level of the masking tone is lower than a difference threshold for a particular user.

20. The method of claim 18, wherein identifying, the calculating, the generating, and the causing are continuously performed while the temperature threshold is being exceeded within the housing of the VR HMD.
